(19) United States
(12) Patent Application Publication
(10) Pub. No.: US 2025/0118930 A1
(43) Pub. Date: Apr. 10, 2025

(54) On-Board Power Supply Connector with External Suspension

(71) Applicant: Auto-Kabel Management GmbH, Hausen i.W. (DE)

(72) Inventors: Richard Reepen, Moers (DE); Rene Mathews, Neuss (DE); Hermann Bommersheim, Bad Nauheim (DE)

(21) Appl. No.: 18/836,212

(22) PCT Filed: Jan. 31, 2023
(86) PCT No.: PCT/EP2023/052238

§ 371 Date: Aug. 6, 2024

(30) Foreign Application Priority Data
Feb. 16, 2022 (DE) 10 2022 103 647.2

(51) Int. Cl. H01R 13/629; H01R 13/52; H01R 13/631; H01R 13/641; H01R 13/6582; H01R 13/66; H01R 13/68; H01R 13/703; H01R 13/713

(52) U.S. Cl. CPC H01R 13/62938; H01R 13/5205; H01R 13/6315; H01R 13/641; H01R 13/6582; H01R 13/6683; H01R 13/68; H01R 13/703; H01R 13/713; H01R 2201/26

(57) ABSTRACT

An on-board power supply connector is proposed, which has a first housing part, in which a first connecting part is arranged, and a second housing part, in which a second connecting part is arranged. In a connected state of the on-board power supply connector, the first connecting part is in mechanical contact with the second connecting part. A spring element engages with the two housing parts of the on-board power supply connector and causes a contact pressure between the two connecting parts indirectly via the housing parts.

The subject matter relates to an on-board power supply connector, in particular for a vehicle on board power supply, in particular in a car, truck or other motorized vehicle. The on-board power supply connector is particularly suitable for high-voltage on-board power supplies.

There are various types of high-voltage on-board power supplies in automotive applications. On the one hand, these can be on-board power supplies with voltages above 12V, for example 24V or 48V. Due to the increasing number of comfort consumers in motor vehicles, it is now being recognized that on-board electrical systems with 48V are advantageous. However, these require different plug connections than is necessary for conventional 12V on-board power supplies. On the other hand, a high-voltage on-board power supply can also be understood as an electrical system for the drivetrain, particularly in vehicles powered by an electric motor. The drivetrain is often operated with voltages of several 100V, for example approx. 400V. In addition to high voltages, high currents are also to be expected on these on-board power supplies, as considerably more power is required to drive the vehicle than to operate the comfort consumers. Particularly high demands are also placed on connectors in such on-board power supplies.

Especially in highly dynamic automotive applications, high demands are placed on the mechanical stability of the on-board power supply connectors. On-board power supply connectors must guarantee a permanently stable and electrically perfect connection. Due to the sometimes high currents, there are also high demands on the contact resistances of such connectors in order to keep the heat loss at the transition low. This requires large contact surfaces between the connecting partners.

To ensure a permanently stable, electrically perfect connection with a low contact resistance and high resistance to dynamic loads, an on-board power supply connector according to claim 1 is proposed.

This on-board power supply connector has a first housing part.

In particular, the first housing part can be formed from side walls and a base. When side walls are referred to here and below, the singular is always meant in addition. The housing part can also have a front face. The first housing part can comprise at least one opening.

A first connecting part is arranged in the first housing part.

In addition to the first housing part, the on-board power supply connector also has a second housing part. In particular, the second housing part comprises side walls and a base. The second housing part can also have a front face. The second housing part can comprise at least one opening.

A second connecting part is arranged in the second housing part.

The two housing parts can in particular be separate from each other. The housing parts can be connectable and/or separable. For example, one housing part can be brought to the other housing part from an arrangement separate from the other housing part, and in particular can be at least partially introduced into the other housing part. For example, one housing part can be arranged in a fixed position in an environment. In this case, the second housing part can, for example, be arranged movably in the environment. Both housing parts can also be arranged movably in an environment.

At least one of the two housing parts or both housing parts can be formed at least partially and/or essentially completely from an electrically insulating material. For example, one housing part may be molded from a plastic, in particular a high-temperature plastic, a ceramic, glass and/or combinations thereof.

At least one of the two and/or both housing parts can be formed in one piece, for example. For example, at least one of the housing parts can be injection molded and/or cast.

At least one of the two and/or both housing parts can have a multi-part structure. For example, several individual parts of a housing part can be connected to one another, in particular in a force-fit and/or form-fit manner. For example, at least one individual part of a housing part can be latched to another individual part of the housing part. Elastic barbs can be provided for this purpose, for example, which bend when two individual parts approach each other and then lock into place with latches provided for this purpose.

If a connecting part is arranged in a respective housing part, the connecting part can be completely enclosed by the housing part. The connecting part can also be arranged only partially within the housing part, i.e. only partially enclosed by it. In particular, the connecting part can penetrate the envelope of the housing part. The envelope can be understood here in particular as the convex envelope. The envelope is of course only to be understood as a theoretical envelope of the housing part, which separates the inside of the housing from the outside of the housing. If the connecting part is completely enclosed by the housing, the connecting part can in particular be completely enveloped by the envelope, in particular the convex envelope, of the housing.

At least one of the connecting parts can be connected to the respective housing part in a force-fit and/or form-fit manner. For example, several individual parts of the housing part can be arranged around the connecting part. For example, the individual parts can be connected to each other and enclose the connecting part so that the housing part is in direct contact with the connecting part and, in particular, fixes it in a form-fitting manner with respect to the housing part. The connecting part can also be riveted in the housing, screwed and/or molded and/or overmolded with at least one individual part of the housing part.

In particular, the second connecting part is formed congruently with the first connecting part. If a connecting part is formed congruently with another connecting part, these can be brought into mechanical contact with one another via at least one contact surface. In particular, the two connecting parts contact each other not only at individual contact points or at spatially very limited individual surfaces, but also via at least one spatially extended contact surface. For example, at least 30%, 40%, 50%, 60%, 70%, 80%, 90%, 95% or 99% of the area enclosed by the contact points between the two connecting parts on the outer surface of one or both of the two connecting parts can be in direct mechanical contact with the respective other connecting part. In all these cases, it is possible to speak of full-surface contact.

For example, one of the two connecting parts can be shaped as a truncated cone and the other as a conical recess. In this case, the congruence of the two connecting parts can be ensured in particular by the fact that their taper angle is essentially the same. Along the longitudinal extent of the truncated cone, and likewise along the longitudinal extent of the conical recess, the diameter of the two can be reduced to the same extent over a given length, for example by the same width or the same diameter. This allows the outer lateral surface of the truncated cone to lie against the inner lateral surface of the conical recess, in particular essentially over the entire surface.

Other shapes of the first and second connecting parts are possible. In particular, one of the two connecting parts can be shaped as a truncated cone, as a rod, as a plug face, as a surface, in particular as a substantially smooth, flat, profiled, curved and/or mechanically coded surface and/or otherwise. A smooth surface can be polished, for example. A flat surface can, for example, be essentially flat, so that it is in particular not curved and/or has essentially no elevations and/or depressions. A profiled surface can, for example, be wave-shaped, have grooves, serrations or other surface forms, in particular regularly shaped surface forms. The respective other connecting part, which is shaped congruently to the one connecting part, forms the mechanical counterpart of the one connecting part. In particular, the respective other connecting part can have recesses where the other connecting part has protrusions. In particular, the recesses can have a shape adapted to the protrusions. The congruent connecting parts can thus engage with each other and/or form a large contact surface with each other. In particular, the two can lie against each other over their entire surface.

Connecting parts that are congruent with each other have the advantage of a large contact surface. In addition, congruent connecting parts can ensure relative alignment of the connecting parts to one another. In particular, the connecting parts can be held in a constant position relative to one another when in contact with one another due to the congruence. For example, if a first connecting part in the form of a cone or truncated cone is inserted into a conical recess of a second connecting part along the longitudinal direction of the truncated cone until the two connecting parts touch each other, they can no longer be displaced relative to each other perpendicular to the longitudinal direction of the truncated cone.

A further advantage of congruent connecting parts is that they can be automatically aligned relative to each other during contacting. Connecting parts that are congruent with each other can also achieve mechanical coding (Poka-Yoke). For example, it can be specified that the two connecting parts can only be joined together in a predefined alignment. In this way, contacting errors can be prevented.

The on-board power supply connector according to the subject matter can comprise several connecting parts per housing part. When the following refers to a connecting part on one of the two housing parts, this also includes several connecting parts on the housing part.

The on-board power supply connector according to the subject matter also comprises a spring element. A spring element is characterized in the present case by the fact that it exerts an elastic restoring force in the event of deformation, which counteracts the deformation. A deformation can, for example, be a compression, expansion, twisting, bending or other change in the shape of the spring element.

For example, a spring element can be a spring, in particular a spiral spring, parabolic spring, wave spring, torsion spring, diaphragm spring and/or involute spring. A spring can be designed as a compression spring, for example. In this case, the spring can be compressed. The restoring force of the spring counteracts the compression. The spring can also be a tension spring, for example. In this case, the spring can be extended and counteracts the extension with its restoring force. A spring can, for example, be made of a metal material, in particular a spring steel such as C60S (1.1211), C67S (1.1231) and C75S (1.1248) or 51CrV4 (1.8159) or X10CrNi18-8, X7CrNiAl17-7, X5CrNiMo17-12-2, X5CrNi18-10 or X22CrMoV121 or X39CrMo17-1 or copper alloys (CuSn 8, CuBe 2) or nickel alloys (Nimonic, Inconel, Duratherm). Springs can also be made of plastics, for example fiber-reinforced plastics.

The spring element can also be made at least partially of rubber, for example. For example, the spring element can have several rubber strands. The spring element can also be at least partially made of foam. The spring element can also be at least partially made of plastic, for example in the form of an elastic clip and/or spring.

A first and a second spring end can be defined for the spring element. The spring element exerts a force between the two spring ends.

The spring element can be mounted on one of the two housing parts. In particular, the spring element can be mounted on one of the two housing parts to prevent loss. For example, the spring element can be held on the housing part by an eyelet, a hook, a recess, a projection, a retaining element provided for this purpose and/or combinations of these. It is also possible for the spring element to be formed as part of the housing part on which the spring element is mounted. The spring element can, for example, be formed essentially in one piece with the housing part. For example, at least one individual part of the housing part and the spring element can be injection molded together, in particular from a plastic, especially an elastic plastic.

In particular, the spring element can be mounted with a spring end on one of the two housing parts.

For example, the spring element can also be separable from at least one and/or both housing parts. The spring element can also be mounted on at least one of the housing parts so that it cannot be lost.

If within this description one element is mounted on another, this comprises in the following a force-fit, form-fit and/or material-fit fastening. Mounted can also mean that one element is movably mounted on the other element, for example rotatably, displaceably, pivotably and/or otherwise movably mounted. Mounted can also mean a permanent connection and/or a detachable connection. Elements mounted together can also be formed in one piece as essentially one element.

For example, several spring elements can also be provided.

The connecting parts are formed from an electrically conductive material and/or coated with it. In particular, the connecting parts can be formed from a copper material or alloys thereof or an aluminum material or alloys thereof. It is also conceivable to coat the connecting parts, in particular on surfaces that come into contact with the other connecting part. A metallic coating, in particular tin plating, silver plating, gold plating, nickel plating and/or combinations of these is possible.

A connected state can be defined for the on-board power supply connector according to the subject matter. In the connected state, the connecting parts in particular come into electrical and/or mechanical contact with each other.

In the connected state, the second housing part can be fixed relative to the first housing part. In the connected state, one of the housing parts in particular can be plugged into the other housing part. For this purpose, at least one housing part can have an opening into which the other housing part can be at least partially inserted.

In the connected state, the second connecting part is in mechanical contact with the first connecting part. The contact surfaces of the connecting parts are in contact with each other. Contact surfaces are, in particular, on the one hand an outer lateral surface of a connecting part, which is in direct contact with an inner lateral surface of another connecting part. For example, a first connecting part can be formed as a truncated cone and the second connecting part as a conical recess. The outer lateral surface of the truncated cone can rest against the inner lateral surface of the conical recess when connected.

In order to establish a good electrical connection, the contact surfaces of the connecting parts must be firmly connected to each other. In particular, there should be a normal force between the contact surfaces. Furthermore, to ensure dynamic stability, this connection must also be fixed in dynamic environments. For this purpose, it is proposed that the two housing parts of the on-board power supply connector are fixed to each other in such a way that the spring element exerts a spring force from a first of the two housing parts onto the second of the two housing parts. In particular, the spring element exerts a spring force in a spring direction. In particular, the spring force on the housing parts causes a contact pressure between the first housing part and the second housing part.

In particular, the first and/or the second connecting parts are fixed relative to the housing part in which they are arranged. In particular, the respective connecting part can be fixed relative to the housing part in the spring direction and/or in all spatial directions. This makes it possible to transfer a spring force, which acts on the housing part, to the connecting part.

The relative fixing of the housing part and connecting part to each other also ensures that elements that are connected to the connecting part can also be fixed relative to the housing part. The fact that there is no relative movement between the connecting part and/or elements connected to it and the housing part means that transitions between the housing part and the connecting part and/or elements connected to it can be permanently sealed, for example. For example, an electrical conductor, such as a cable, which is mechanically and/or electrically connected to the connecting part, can be led out of the housing part in a sealed manner. Since the housing part and electrical conductor are fixed to each other, the lead-out can be permanently sealed, in particular gas-tight and/or fluid-tight and/or liquid-tight. In particular, only reduced mechanical forces act between the housing part and the electrical conductor in the area of the lead-out, especially in the area of any insulation on the lead-out, as the two are already fixed to each other.

To establish the connected state of the on-board power supply connector according to the subject matter, the two housing parts and/or the two connecting parts can be brought closer together until the two connecting parts touch each other. In particular, the two housing parts and/or connecting parts can be brought closer together in a mating direction.

The mating direction can be defined for each housing part in particular. The mating direction is directed from the respective housing part towards the other housing part. The two housing parts can be brought closer to each other in a straight line in the respective mating direction and thus reach the end position in which the respective connecting parts are mechanically and electrically connected to each other.

The two housing parts can also be brought at least partially into contact with each other. In particular, the two housing parts can be formed in such a way that they themselves do not have a stop in the plug-in direction. In particular, the connecting parts can form the stop between the first housing part and the first connecting part on the one hand and the second housing part and the second connecting part on the other hand in the plug-in direction. Due to the relative fixing of the connecting part in its respective housing part, a contact between the connecting parts also causes a relative fixing of the two housing parts to each other.

The surfaces of one housing part that rest against the other housing part can, for example, be aligned essentially parallel to the plug-in direction. This can ensure that the two housing parts can be moved along each other in the plug-in direction and/or can slide along each other. For example, several walls can be provided on at least one housing part, which are arranged essentially parallel to the plug-in direction and parallel to each other. In particular, the walls can be arranged in the vicinity of the opening, in particular around the opening, in particular circumferentially. There may be a gap between the walls. The walls can, for example, be formed as a collar, in particular around the opening.

The two housing parts can be pushed along each other along an overlap distance, in particular when the connected state is established, while they are at least partially in mechanical contact with each other, in particular circumferentially, in particular circumferentially around the connecting part. The mechanical contact can be direct and/or indirect, for example via at least one seal, in particular via a sealing ring with in particular at least one sealing lip.

When the term “essentially vertical” is used here and in the following, this refers to an angle range of 90°+/−25°, in particular 90°+/−15°, in particular 90°+/−5°. When the term “essentially parallel” is used here and in the following, this refers to an angular range of 0°+/−25°, in particular 0°+/−15°, in particular 0°+/−5°.

In particular, the two housing parts can be guided along each other in mechanical contact, especially circumferential mechanical contact, starting from the connected state with adjacent connecting parts along the opposite mating direction. The connecting parts are separated while the two housing parts are still in mechanical contact with each other.

The housing parts can therefore overlap each other when connected, in particular, one of the housing parts can be pushed into another of the housing parts. The overlap of the two housing parts can in particular be arranged circumferentially around at least one opening of at least one of the housing parts. In particular, the overlap can measure an overlap distance, especially in the direction of insertion. In the area of the overlap, at least one seal, in particular a circumferential seal, can be arranged between the two housing parts. In particular, at least two or more seals can be provided, which are spaced apart from each other, especially along the mating direction.

The seal, in particular the distance between the sealing lips furthest apart in the mating direction, or in the case of several seals the greatest distance between the seals in the mating direction, can for example measure at least 20%, 30%, 40%, 50%, 60%, 70%, 80% or in particular 90% of the overlap distance.

When connected, the connecting parts are pressed together by the spring element. The spring element thus creates a contact pressure between the connecting parts. As described above, the spring element acts indirectly on the connecting parts via the housing parts. The spring element is in mechanical contact with both connecting parts.

In the connected state, the spring element is compressed in particular. The restoring force of the spring element, which acts in the direction of the expansion of the spring element, presses the two connecting parts against each other so that there is contact pressure between them.

In the connected state, the spring element can also be expanded, for example. In this case, the restoring force of the spring element acts in the direction of a shortening of the spring element starting from the expanded state. In this case too, the restoring force of the spring causes the connecting parts to press against each other.

When “the spring element” is mentioned, both a single spring element and several spring elements are included.

The spring element can, for example, be arranged at least partially within one of the two housing parts, in particular the housing part on which the spring element is mounted. The spring element can also be arranged at least partially and/or completely outside at least one and/or both housing parts. An arrangement of the spring element at least partially outside at least one of the housing parts has the advantage that the connecting parts can initially be placed against each other to produce the connected state, whereby in particular the interior, which is enclosed by the two housing parts, is closed. The spring element can then be deformed, in particular compressed or expanded, to achieve the contact pressure between the two connecting parts.

Since the spring element engages on the outside of the housing parts, no moving element needs to engage from the outside in the interior space described by the housing parts, particularly after the connecting parts and/or housing parts have made contact. In this way, it can be ensured that the interior of the housing parts is permanently sealed from the environment.

For example, a fixing element can be provided for mechanical connections between the spring element and the first and/or second housing part. When the on-board power supply connector is connected, the fixing element can mechanically connect the spring element to the first and/or second housing part.

In particular, the fixing element can be multi-part. It is also possible for the fixing element to be designed in one piece.

The fixing element can be arranged in a captive manner on one of the two housing parts. In particular, the fixing element can be movably mounted on one of the two housing parts. For example, the fixing element can be mounted on one of the housing parts so that it can rotate about an axis. The fixing element can, for example, be a part of one of the two housing parts, in particular be formed in one piece with one of the two housing parts, for example by injection molding.

When the on-board power supply connector is connected, the two housing parts are in indirect mechanical contact with each other, in particular via the two connecting parts. In addition, the two housing parts can be in indirect mechanical contact, in particular via the spring element or the spring element and the fixing element. The spring element or the combination of fixing element and spring element can exert a spring force in the spring direction on the two housing parts and thus on the two connecting parts, so that there is contact pressure between the connecting parts.

For example, the spring force direction is essentially parallel to the plug-in direction of the On-board power supply connector according to the subject matter.

The fixing element is designed, for example, to bring one of the two spring ends of the spring element into contact with one of the two housing parts. For example, the fixing element can be set up to press a compressible spring element, in particular a compression spring, with one spring end onto one of the housing parts, in particular while the other spring end is connected to the fixing element. The fixing element can also attach an expandable spring element, in particular a tension spring, with one spring end to one of the housing parts.

The fixing element has, for example, at least one retaining element. In particular, the retaining element can be designed to be connected to one of the two housing parts. For example, a fastening means can be provided on one of the housing parts for this purpose. A fastening means can be, for example, a hook, a barb, a clip, a latch, a lever, a slack element, a screw element, a nail, a velcro element, a strap, a chain and/or a combination thereof. For example, the fixing element can be mounted on one of the two housing parts, in particular be mounted in a captive and/or movable manner, while the retaining element serves to connect the fixing element to the other of the two housing parts.

A fastening means can be firmly mounted on the housing part. The fastening means can also be spring-mounted on the housing part, for example.

According to one embodiment, the fixing element, in particular as a retaining element, has a fixing lever mounted on one of the two housing parts so that it can pivot about an axis. In particular, the axis is aligned essentially perpendicular to the spring direction. The fastening lever can be in engagement with a fastening means on the other of the housing parts, particularly when the On-board power supply connector is connected. In particular, the fastening lever can be locked in the connected state. A lever holder can be provided for this purpose, for example on the housing part on which the fastening lever is mounted.

According to a further embodiment, the fixing element comprises one or more clamps that can engage with one of the housing parts and/or both housing parts. For example, the clip can be mounted on one of the two housing parts, and in particular the clip can be formed as part of one of the two housing parts. In the connected state, the clip can engage with the other housing part. For this purpose, for example, a latching lug, a recess and/or a projection can be arranged on the other housing part.

In one embodiment, a part of the fixing element, in particular a clip, can be designed to be elastic. In particular, the clip can be deformed when the two housing parts approach each other and can latch with one of the two housing parts when the connected state of the on-board power supply connector is reached.

In one embodiment, the spring element is part of the fixing element. The fixing element can be made of an elastic material, for example. In particular, the fixing element can be formed in such a way that the fixing element can elastically absorb deformations, in particular compression and/or expansion, in particular in the direction of insertion, and thus acts as a spring element.

The fixing element can assume the function of tensioning the spring element, in particular compressing or expanding it. A tensioning lever can be provided for this purpose. The tension of the spring element can also be achieved by deforming the spring element in some other way, for example by manual deformation. In this case only, the fixing element can be used purely to maintain the deformation of the spring element.

In one embodiment, at least part of the fixing element is formed as a cover. The cover can, for example, provide an at least partial enclosure for the spring element. The cover can, for example, be mounted on one of the housing parts so that it cannot be lost. For example, the cover can have at least one form-fitting fastening means for this purpose, in particular a clip, a clip, a latching element and/or a combination of these. The cover can, for example, ensure a captive mounting of the spring element on the housing parts.

In particular, the cover has a base and a collar. The collar can, for example, be aligned essentially parallel to the spring direction of the spring element. The base can, for example, be aligned essentially perpendicular to the spring direction of the spring element. For example, the housing element on which the cover is arranged can also have a collar. This collar can also be aligned essentially parallel to the spring direction, for example. The collar of the cover and the collar of the housing part can overlap each other in the spring direction, for example. An at least partially closed space can be defined by the cover, in particular its collar, and/or the collar of the housing part, which is arranged between the housing part and the cover. For example, the spring element can be at least partially arranged in this space.

According to one embodiment, the spring element is mounted on one of the housing parts at least partially between the housing part and a part of the fixing element, in particular the cover.

The fixing element can comprise a slide. In particular, the slide can be movably mounted on the housing part. In particular, the slide can be movably mounted on the housing part in the spring direction. For example, at least one guide can be provided for this purpose.

For example, a channel can be provided in the housing part, which extends essentially parallel to the spring direction. The fixing element, in particular the slide, can have a matching guided element, for example a rod, a rail, a roller and/or another element to be guided that is adapted to the guide.

At least one part of the spring element, in particular the slide, can have a stop on the housing part on which it is mounted. In particular, the spring element can be held in a preload by the stop. This means that the spring element is already preloaded before the on-board power supply connector is connected. The stop can prevent the spring element from switching to a fully relaxed, force-free configuration.

The slide can therefore be held against the stop with a residual tension by the spring in an unconnected state of the on-board power supply connector. In particular, the stop is formed at least partially as part of the housing part on which the spring element is mounted. In particular, the stop of the housing part is formed in one piece with at least one part of the housing part. The slide also has a stop that can rest against the stop of the housing part. For example, the slide can have one or more protrusions and/or recesses, in particular one or more hooks, in particular elastic hooks, which rest against a stop, in particular a protrusion and/or recess, of the housing.

The spring element is always in a well-defined position and alignment due to the pre-tensioning of the spring element. In particular, it no longer needs to be brought into position to establish the connected state of the On-board power supply connector.

The use of a slide on the housing parts on which the spring element is mounted has the advantage of being able to pre-tension the spring element. In addition, the use of a slide has the advantage that the spring element is guided. The spring element can also be at least partially enclosed between the slide and the housing part. This protects the spring element. This has advantages for the durability of the On-board power supply connector and also for its manageability. For example, spring elements are often made of electrically conductive metal materials, the open accessibility of which poses risks in the environment of a high-voltage vehicle network.

The slide can be identical to the cover. The features of the slide described above, including the guide, stop and all other features, can also be present on the cover, as well as the counterparts provided for this purpose on the respective housing part.

In this way, the cover, which in particular partially houses the spring element, can also guide the spring preload and the spring.

In one embodiment, the fixing element has a retaining element mounted on the slide and/or the cover. In particular, the retaining element can be engaged with a fastening means on the other of the housing parts. For example, the retaining element can be formed as a hook, such as a flexible hook, clip or snap element. The retaining element can also be formed as a strap, for example, or as a rod, a sheet, a stick, in particular with a hole or another retaining element. The retaining element can, for example, bridge the distance between the fixing element, in particular the slide and/or the cover, which are arranged in particular on one of the two housing parts, up to the second housing part, in particular up to the fastening means of the second housing part. The retaining element can thus set a predetermined distance between the fixing element, in particular the slide and/or the cover, and the second housing part. As long as the retaining element is engaged with the fastening means of the second housing part, a distance is set between this second housing part and at least part of the fixing element.

In one embodiment, the retaining element can be formed in one piece with a part of the fixing element, in particular the cover and/or the slide.

The fastening means can be, for example, a recess, an elevation, a hole, in particular a blind hole and/or a through hole, a barb, a snap element, a thread, a magnetic fastener and/or a combination thereof. In particular, the fastening means can be formed in one piece with the second housing part. It is also possible to provide the fastening means as an element separate from other individual parts of the second housing part.

According to one embodiment, the fastening element comprises a fastening lever pivotably mounted about an axis. In particular, the axis is aligned essentially perpendicular to the spring direction. The fastening lever can be in engagement with a fastening means on the other of the housing parts, in particular in the connected state of the On-board power supply connector. In particular, the fastening lever can be locked in the connected state. A lever holder can be provided for this purpose, for example on the housing part on which the fastening lever is mounted.

As already explained above, the two connecting parts can be shaped congruently to each other. In one embodiment, one of the connecting parts has a sleeve-shaped receptacle and one of the connecting parts has a rod-shaped plug-in element that is congruent with the receptacle. The sleeve-shaped receptacle can, for example, have a conical recess. The rod-shaped plug-in element can also be shaped like a truncated cone, for example. In particular, the plug-in element can be inserted into the receptacle when the On-board power supply connector is connected. In particular, the receptacle can taper, especially conically, from an opening at the front towards a base of the receptacle. The plug-in element can taper towards its front face, in particular taper conically.

In the connected state, an inner lateral surface of the receptacle and an outer lateral surface of the plug-in element can be in direct contact with each other. In particular, a gap can be arranged between the front face of the plug-in element and the base of the receptacle in the connected state. The gap can ensure that the contact pressure between the connecting parts is absorbed by the lateral surfaces.

In one embodiment, an end piece, in particular made of an insulating material, can be arranged on the front face of the plug-in element. The end piece is arranged in particular on the area of the plug-in element that is closest to the other connection element when it is brought together. For example, the connecting part, in particular the plug-in element, can then be provided with a front face receptacle for an end piece. That one piece can, for example, be plugged onto the connecting part, in particular onto its front face receptacle.

In one embodiment, an insulator arranged on the front face and at least partially covering the front face is arranged on one of the connecting parts. For example, an insulator can be arranged at the front face end of the receptacle, in particular all the way around the receptacle. For example, in the case of an essentially round receptacle, an insulator ring can surround the receptacle.

The connecting part, which is formed as a receptacle, can be surrounded on its outer surface by an insulating sleeve. For example, at least one recess and/or projection can be provided on this connecting part, on which an insulating sleeve can be latched. The insulating sleeve can, for example, also have at least one projection and/or a recess, which can engage with the recess and/or projection of the connecting part.

An insulator on a connecting part serves, for example, to protect against contact and increases safety when handling the On-board power supply connector according to the subject matter.

According to one embodiment, the first housing part and/or the second housing part can have an opening. In the connected state, one of the two housing parts in particular can be at least partially inserted into the opening of the other housing part. In this case, the two housing parts overlap. In particular, the first housing part can be inserted into an opening of the second housing part in the connected state. Alternatively or additionally, the second housing part can be inserted into an opening of the first housing part in the connected state.

A respective opening of a housing part can have an axial extension. In particular, the axial extension can be aligned essentially parallel to the direction of insertion. For example, the opening can be limited by a lateral inner lateral surface, which at least partially runs essentially parallel to the direction of insertion.

A housing part can have an outer lateral surface. In particular, an outer casing surface can be provided in the form of a collar around an opening. For example, the outer casing surface may be at least partially aligned substantially parallel to the plug-in direction.

According to one embodiment, the collar of a first housing part, which is arranged in particular around an opening of the first housing part, in particular circumferentially around an opening, can be cross-sectionally matched to the inner lateral surface of an opening of the second housing part. The collar of the first housing part can thus be guided into the opening and along the inner lateral surface of the second housing part. In particular, the collar of the first housing part and the inner circumferential surface of the first housing part can overlap with one another in the axial direction of the opening when connected. In particular, the collar and the inner lateral surface can have an overlap along the mating direction. Both housing parts can also each have a collar which surrounds the respective opening, in particular circumferentially.

The axial extension of the opening of one of the housing parts and/or both housing parts can, in particular, be aligned essentially parallel to the plug-in direction and/or spring direction.

For example, at least one of the housing parts can have several collars, which in particular surround the opening, especially circumferentially. For example, two collars can be arranged on one of the housing parts, which are aligned essentially parallel to the insertion direction and parallel to each other, so that a gap is formed between the collars, in particular essentially perpendicular to the insertion direction. A collar of the other housing part can be inserted into the gap. For example, a seal can be arranged in the gap between the collars of the first connecting part, in particular on an inner and/or outer lateral surface of one of the collars. The width of the gap can correspond to the material thickness of the collar of the other housing part plus the thickness of the seal. In particular, the gap can be narrower than the sum of the material thickness of the collar of the other housing part and the thickness of the seal. This allows increased contact pressure to be achieved between the collar and the seal when the collar of the other housing part is inserted into the gap. The collar of the other housing part, which is guided between the two collars of the one housing part, can thus be held firmly between the seal and a collar of the one housing part. At least one of the collars described can also be an inner lateral surface of an opening of a housing part.

According to one embodiment, at least one seal can be arranged on an outer lateral surface of at least one of the housing parts. In particular, a seal can be arranged in the area of an opening of the housing part. In particular, the seal can be arranged circumferentially, in particular circumferentially around the opening. In particular, a seal can be arranged on an outer lateral surface of one of the housing parts, which is in contact with an inner lateral surface of the other housing part when the on-board power supply connector is connected. At least one seal, in particular a circumferential seal, can also be arranged on the inner lateral surface of one of the housing parts, which is in contact with an outer lateral surface of the other housing part in the connected state.

In particular, the seal can have several sealing lips. The sealing lips can each follow the circumferential course of the seal. The sealing lips can be spaced apart from each other along the axial extent of the opening.

In particular, at least two or more seals can be provided.

According to one embodiment, at least one of the connecting parts is mechanically and/or electrically connected to an electrical conductor. The connection can be force-fit, form-fit and/or material-fit. For example, a conductor can be screwed, clamped, riveted, soldered and/or welded to one of the connecting parts.

In one embodiment, the connecting part is indirectly connected to an electrical conductor. For example, a connecting element, in particular made of a metal material, can be connected to the electrical conductor and also connected to the connecting part.

For example, the connecting element can be connected to the conductor with a material bond, in particular soldered and/or welded. The connecting element can, for example, be attached to the connecting part in a force-fit and/or form-fit manner, in particular by screwing.

The electrical conductor can be made of a metal material, in particular aluminum and/or alloys thereof or aluminum and/or alloys thereof.

The electrical conductor can be a stranded conductor, for example. It is also possible for the electrical conductor to be formed from a solid material. For example, the electrical conductor can be a busbar. The busbar can have an essentially rectangular cross-section with two wide sides and two narrow sides.

In particular, the electrical conductor can be formed as a cable. The electrical conductor can therefore comprise an insulation layer that surrounds the electrical conductor. Shielding can also be provided. In particular, the electrical conductor can be surrounded by a first insulation layer, which is surrounded by a shielding, which in turn is surrounded by an outer insulation layer. The shielding can, for example, be in the form of a metal wire mesh and/or in the form of a foil, in particular a metal foil.

In one embodiment, at least one of the two housing parts has a conductor holder. The conductor holder can be used to hold the conductor. In particular, the conductor holder can be formed as a feed-through of the electrical conductor from the surroundings of the housing part into the housing part. The conductor holder can, for example, be shaped as an opening in the housing part. The conductor holder has an axial extension which extends, for example, along the longitudinal direction of the electrical conductor. The axial extension of the conductor receptacle can, in particular, run at an angle, in particular essentially perpendicular to the spring direction and/or plug-in direction.

The conductor holder can, for example, have at least one seal. In particular, the seal can enclose the electrical conductor, which is guided into the conductor holder, all the way around. In particular, the electrical conductor including the insulation layer can be enclosed by the seal. The seal can therefore be in contact with the conductor all the way around. In this way, tightness of the transition between the conductor and the interior of the housing part can be ensured. In particular, the transition can be gas-tight and/or fluid-tight. The seal of the conductor holder can have several sealing lips, which are spaced apart from each other, in particular along the axial extent of the conductor holder. Several seals, in particular such seals, can also be provided.

The conductor holder can be adapted to the cross-section of the electrical conductor. In particular, this can mean that the conductor can be inserted into the conductor holder. In particular, the conductor can be positioned centrally within the conductor holder so that it has a substantially equal distance to the conductor holder on all sides along its cross-sectional circumference perpendicular to the axial extension of the conductor holder.

In one embodiment, the electrical conductor has a shield. In particular, the shielding can be electrically connected to at least one sleeve. The sleeve can be arranged in a housing part, in particular the housing part into which the electrical conductor is inserted. The sleeve surrounds at least one connecting part, particularly when connected. This means that the shielding function can also be ensured in the area of the transition between the two connection elements. For example, a first sleeve can be arranged around the first connecting part in the first housing part. A second sleeve can be arranged around the second connecting part in the second housing part. When the connecting parts are in contact with each other in the connected state, the two sleeves can also be at least partially in contact with each other and thus establish an electrical contact. In this way, both the two connecting parts and the shielding surrounding the connecting parts are electrically connected. The current path, which is closed by the on-board power supply connector, is therefore shielded throughout.

When the term “electrical conductor” is used, it also comprises a cable.

In one embodiment, one of the two housing parts can be embedded in an electrically conductive housing. In particular, the conductive housing can be connected to the shielding of the conductor when the on-board power supply connector is connected.

According to one embodiment, at least two first connecting parts are arranged in the first of the two housing parts. Two second connecting parts can also be arranged in the second of the two housing parts. In particular, pairs of first and second connecting parts can thus be defined. In an embodiment with two first connecting parts and two second connecting parts, a first of the two first connecting parts can be connected to a first of the two second connecting parts. A second of the two first connecting parts can also be connected to a second of the two second connecting parts. The respectively connected first and second connecting parts, one of which is arranged in the first housing part and one of which is arranged in the second housing part, can be defined as a pair of first and second connecting parts.

According to one embodiment, the spring element can provide a contact pressure for all pairs of first and second connecting parts of the on-board power supply connector. In particular, the first connecting parts can be fixed relative to the first housing part. If the spring element now exerts a force on the first housing part, it exerts a force on the first connecting parts. The second connecting parts can also be fixed relative to the second housing part. A force on the second housing part therefore has an effect on the second connecting parts. The spring element therefore acts on all pairs of first and second connecting parts of the On-board power supply connector.

According to one embodiment, a respective spring element is assigned to one of the connecting parts. In particular, a spring element can be assigned to a respective pair of first and second connecting parts. In particular, at least one of the many elements can be aligned with at least one pair of first and second connecting parts, in particular in the direction of insertion. This results in uniform contact pressure for all pairs of respective first and respective second connecting parts.

According to one embodiment, one, in particular the second, of the two housing parts has a securing element. In particular, a securing element can be operated by mechanical contact. In particular, the safety element can be a switch, which is closed or opened by mechanical contact with a further element.

A safety element can detect the presence of a further element in a certain position, in particular in the vicinity of the safety element. An evaluation device can be connected to the securing element. This can, for example, be set up in such a way that it de-energizes a conductor if the safety element does not detect the presence of another element.

In one embodiment, one of the two housing parts, in particular the first of the two housing parts, has a channel that extends in particular in the direction of the spring.

In particular, the channel can be used to guide a part of the fixing element. In particular, the channel can serve as a guide for the slide, i.e. also for the cover. The channel can also be provided independently of a guide for a part of the fixing element.

According to one embodiment, the channel serves at least in part as a securing channel. A part of the fixing element can be guided through the securing channel. For example, this can be a part of the slide and/or the cover. Other parts of the fixing element can also be guided in the securing channel. In particular, a part of the fixing element can be guided into the second of the two housing parts.

For example, the fixing element can have at least one or more seals in the area that is inserted into the securing channel. In particular, a seal, especially a circumferential seal, can be arranged on an outer surface of the fixing element. The seal can be in circumferential contact with the inner lateral surface of the securing channel. At least one circumferential seal can also be arranged on the inner lateral surface of the securing channel. In both arrangements, the seal can have circumferential mechanical contact with both the inner lateral surface of the securing channel and the fixing element. This allows the interior of the housing to be sealed off from the environment of the On-board power supply connector, in particular a gas-tight and/or fluid-tight seal. At the same time, the movement of the fixing element, in particular the slide and/or the cover, can be detected inside the housing.

A part of the fixing element can, for example, be permanently arranged in the securing channel, in particular both in the disconnected and in the connected state of the On-board power supply connector.

In particular, the mechanical connection between the fixing element and the inner surface of the securing channel, in particular indirectly via at least one seal, can be established permanently, in particular both in the disconnected and in the connected state of the On-board power supply connector.

The opening of the fuse channel in the first housing part can be arranged in particular in an area of the first housing part that is covered by the cover. In particular, a collar can be arranged around the opening of the fuse channel on the outer surface of the first housing part. The cover can be slipped over the collar. In particular, the cover can also have a collar which extends from a base of the cover towards the first housing part. In particular, the collar can be aligned at least essentially parallel to the insertion direction.

The two collars of the cover and the first housing part can overlap each other in the direction of insertion. This provides further protection for the safety channel. The spring element arranged between the cover and the first housing part in some embodiments is also protected in this way.

In one embodiment, the fixing element actuates the securing element, particularly when the On-board power supply connector is connected. For example, the fuse element can be designed as a fuse switch. The fixing element, in particular the part of the safety element inserted into the safety channel, can close a safety switch, in particular when the on-board power supply connector is connected. The fuse element can be arranged in the second of the two housing parts in particular. The fuse channel can be arranged in the first of the two housing parts and, in particular, aligned with the fuse element.

According to a further embodiment, a temperature sensor can be provided. The temperature sensor can be arranged in one of the two housing parts. For example, the temperature sensor can be arranged in the second of the two housing parts, in particular in the housing part in which the securing element is arranged.

The object of the invention is explained in more detail below with reference to a drawing showing embodiments. In the drawing show:

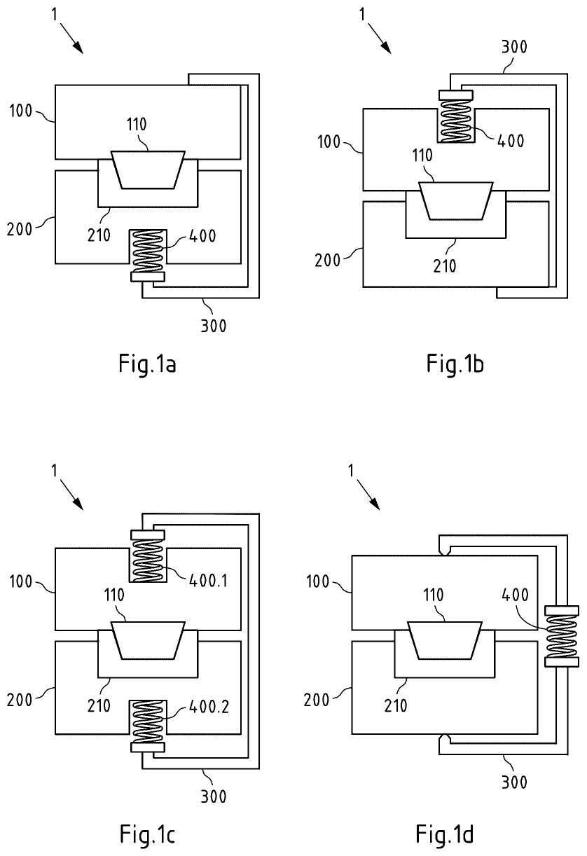

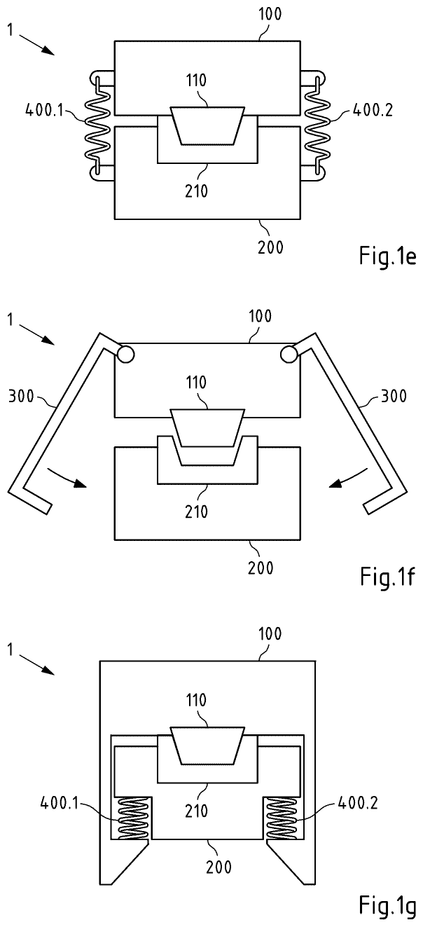

FIG. 1a-g schematic side views of the on-board power supply connector according to the subject matter according to an embodiment;

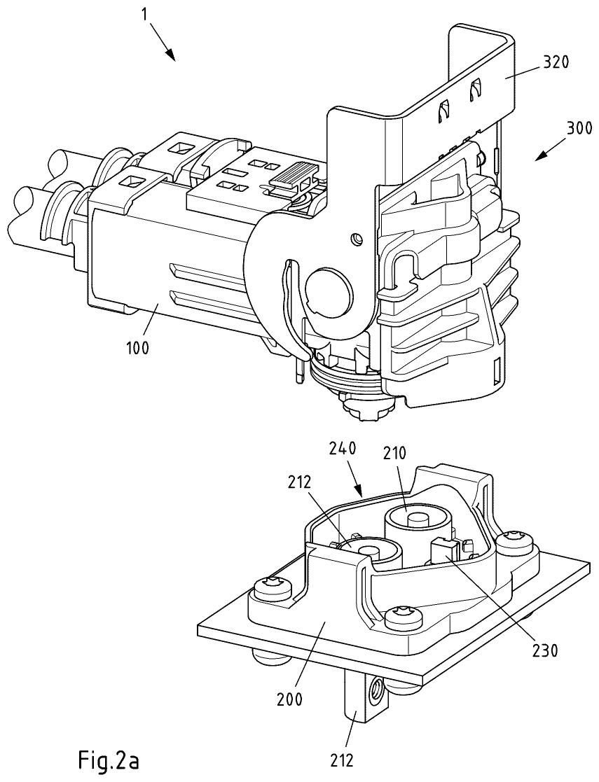

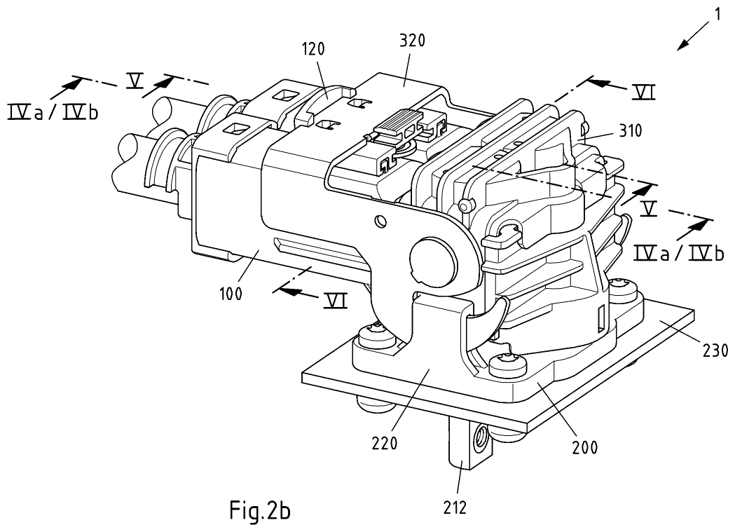

FIG. 2a an isometric view of the on-board power supply connector according to the subject matter in the disconnected state according to an embodiment;

FIG. 2b an isometric view of the on-board power supply connector according to the subject matter in the connected state according to an embodiment;

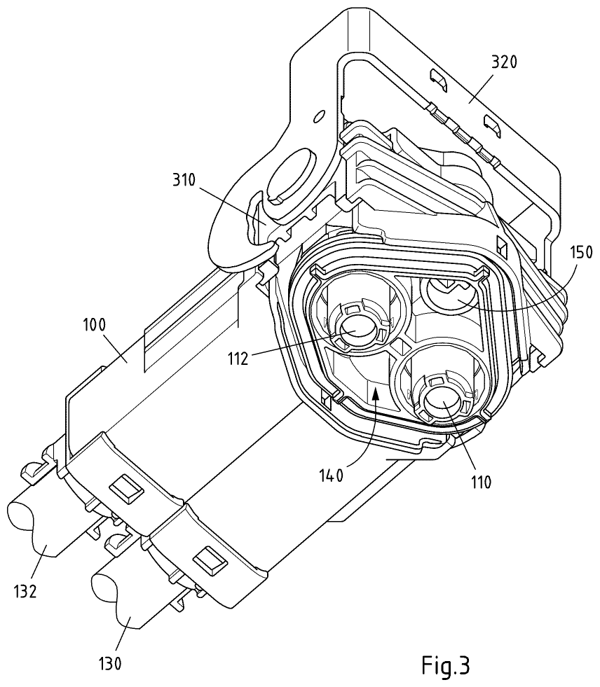

FIG. 3 an isometric view of the first housing part of the on-board power supply connector according to the subject matter according to an embodiment;

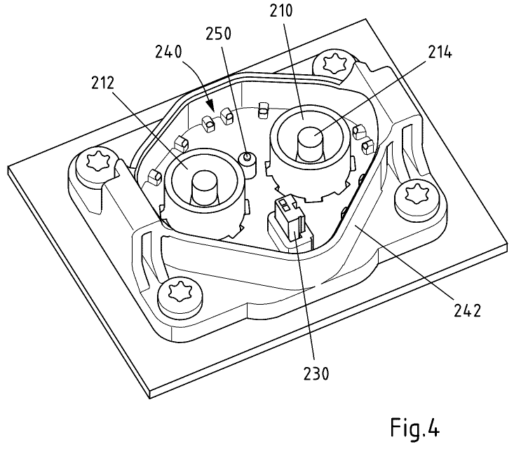

FIG. 4 an isometric view of the second housing part of the on-board power supply connector according to an embodiment;

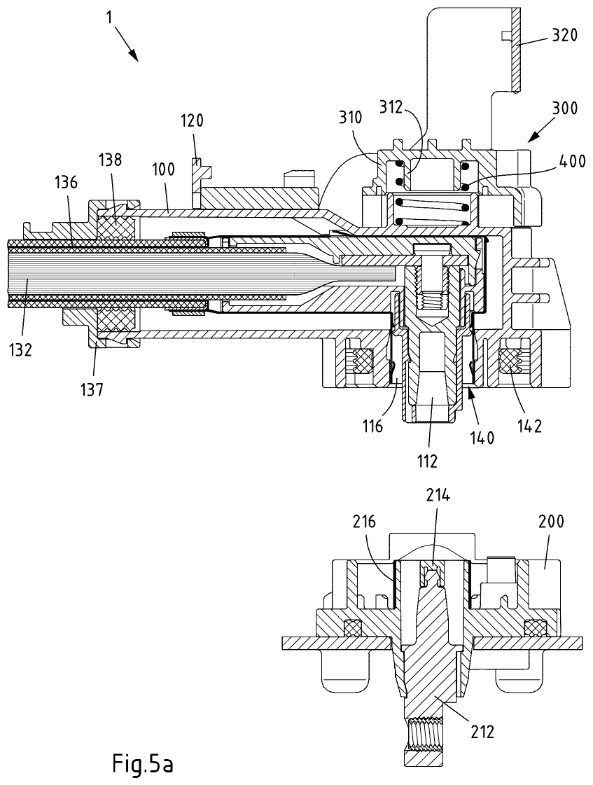

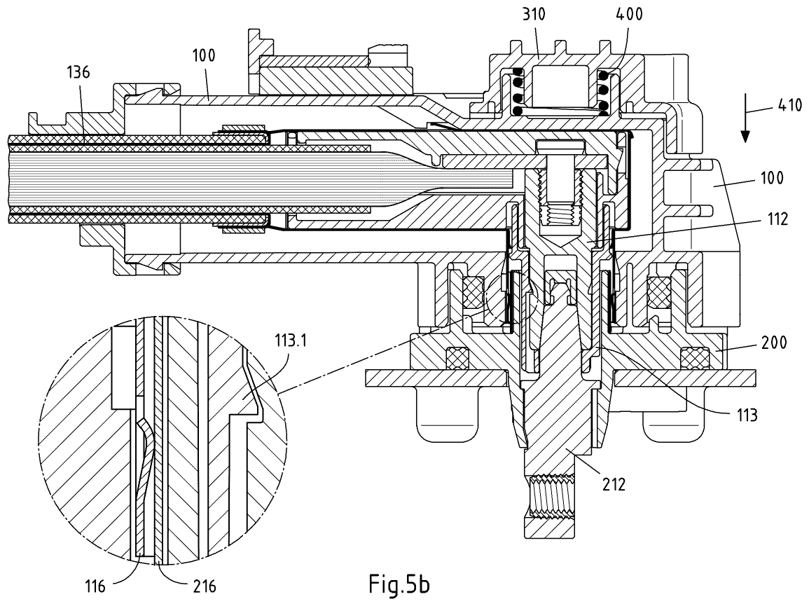

FIG. 5a a sectional view of the on-board power supply connector according to the subject matter in the disconnected state according to an embodiment;

FIG. 5b a sectional view of the on-board power supply connector according to the subject matter in the connected state according to an embodiment;

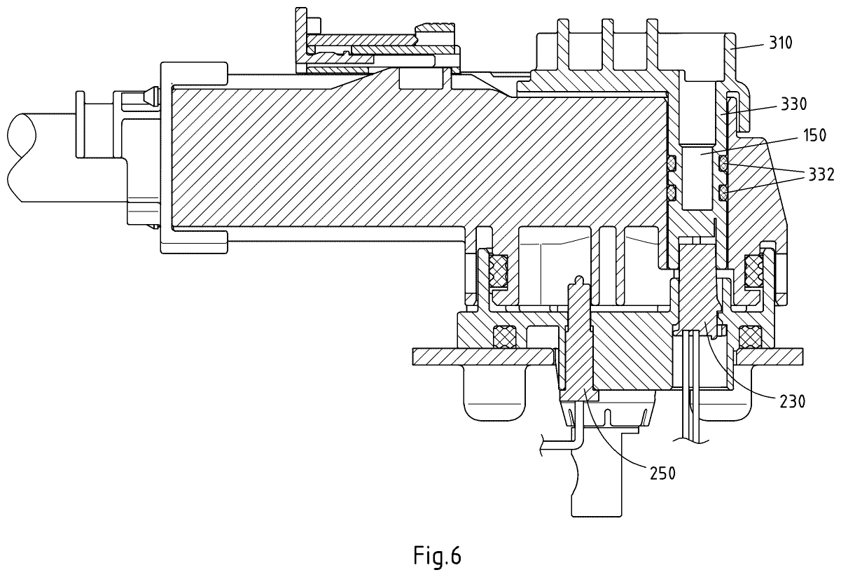

FIG. 6 a sectional view of the first housing part of the on-board power supply connector according to the subject matter according to an embodiment;

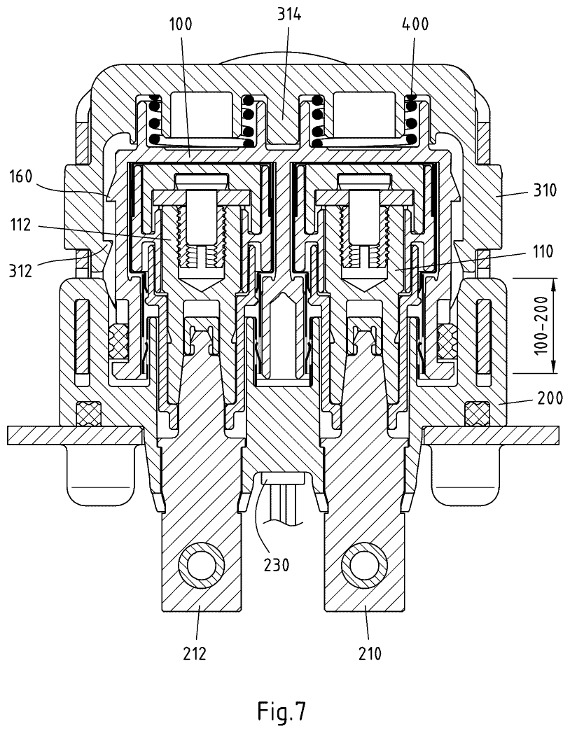

FIG. 7 a sectional view of the first housing part of the on-board power supply connector according to the subject matter according to an embodiment;

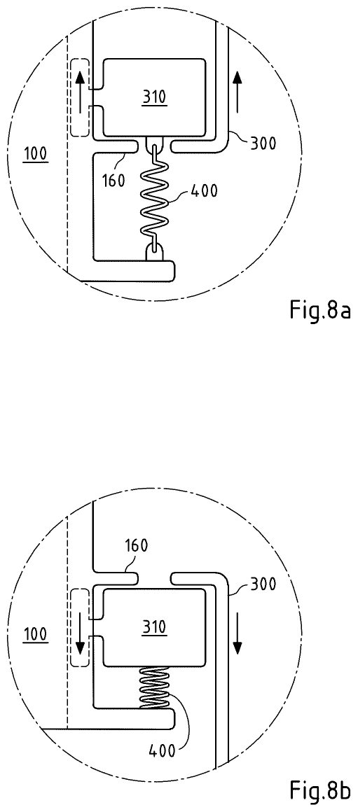

FIG. 8a,b a sectional view of the stop of the fixing element on the first housing part of the on-board power supply connector according to the subject matter according to an embodiment.

FIG. 1 shows various schematic designs of the on-board power supply connector 1 according to the subject matter.

In FIG. 1a, the first housing part 100 with the first connecting part 110 is arranged at the top. The second housing part 200 and the second connecting part 210 can be seen below it. Furthermore, a spring element 400 is arranged on the second housing part 201. A fixing element 300 connects the first housing part 100 and the second housing part 200 indirectly via the fixing element 300 and the spring element 400. Due to the fixed arrangement of the connecting parts 110 and 112 in the first housing part 100 and the second housing part 200, the spring element 400 in combination with the fixing element 300 presses them together indirectly via the housing parts 100, 200 with a contact pressure.

In the embodiment shown in FIG. 1b, the spring element 400 is arranged on the first housing part 100.

FIG. 1c shows an embodiment with two spring elements 400.1 and 400.2, which are each arranged on the housing parts 100, 200.

While the embodiments in FIGS. 1a-c show spring elements 400 which are compressed to generate the contact pressure between the connecting parts 110 and 210, in particular compression springs, FIGS. 1d and 1e relate to embodiments with spring elements which are expanded, in particular tension springs.

In FIG. 1d, the spring element 400 is integrated into the fixing element 300. The spring element 400 is therefore in particular not arranged directly on one of the two housing parts 100, 200.

FIG. 1e shows another embodiment in which no separate fixing element 300 is used, but only spring elements 400.1 and 400.2 are attached to the housing parts 100, 200.

The fixing element 300 can take various forms. In FIGS. 1a to d, they take the form of a bracket which encloses the two housing parts 100, 200. In FIG. 1e, no fixing element 300 is provided at all, in addition to the spring elements 400.1, 400.2. Figures if, g show further alternative embodiments of the fixing element 300.

In Figure if, two brackets are provided as fixing elements 300. The brackets are rotatably mounted on the first housing part 100 and can engage under the second housing part 200 by rotation. In this case, the fixing elements 300 can themselves be elastic and accordingly act as spring elements 400.

FIG. 1g shows a further embodiment in which the upper housing part 100 has snap-in elements 300 which can engage under the second housing part 200. There they come into contact with the spring elements 400.1, 400.2, which can cause the contact pressure between the connecting parts 110 and 210.

FIGS. 2a, b show a more detailed example of an on-board power supply connector 1.

FIG. 2a shows the unconnected state of the on-board power supply connector 1. The first housing part 100 with a fixing element 300 can be seen. Part of the fixing element 300 is a fastening lever 320. The second housing part 200 is shown below this. This has an opening 240. The two connecting parts 210 and 212 are positioned in the opening 240. A securing element 230 is also located in the opening 240.

FIG. 2b shows an on-board power supply connector 1 according to the embodiment from FIG. 2a in the connected state. It can be seen that the fixing element 300 engages with its fastening lever 320 in a fastening means 220 provided for this purpose. The lever 320 is also locked in a lever holder 120. The fixing element 300 also comprises a slide 310, which in the embodiment shown can be referred to as a cover. The second housing part 200 is connected to a plate 230. In particular, the plate can be electrically conductive. It can also be seen that at least one of the connecting parts 210, 212 has a thread for connection to an electrically conductive element.

FIG. 3 shows an isometric view of the first housing part 100 of the on-board power supply connector 1 according to the subject matter. Two electrical conductors 130, 132 are led into the first housing 100. An opening 140 of the first housing 100 can also be seen, in which two connecting parts 110, 112 are arranged. It can also be seen that the fixing lever 320 of the fixing element 300 is rotatably arranged on the slide 310. In the form shown, the fixing element 300 and in particular the slide 310 and the fixing lever 320 can therefore be displaced relative to the first housing part 100, in particular parallel to the insertion direction.

FIG. 4 shows an isometric view of the second housing part 200. Two connecting parts 210, 212 are arranged in an opening 240 of the second housing part 200. Caps 214 can be seen on these. In particular, the caps 214 can be formed from a non-electrically conductive material. In addition, a fuse element 230 and a temperature sensor 250 can be seen inside the opening 240. In the embodiment shown, no seal is arranged on the collar 242 FIG. 5a shows a sectional view of the on-board power supply connector 1 according to the subject matter along the sectional plane IVa/IVb. In addition to the components already explained above, the spring element 400 in particular can be seen here. In the embodiment shown, the spring element 400 is a spiral spring. This is arranged between the first housing part 100 and the slide 310. The slide 310 takes the form of a cover. It can be seen that the slide 310 and the first housing part 100 together completely enclose the spring, even in the unconnected state shown.

The collar 312 of the slide 310 is arranged inside the coil spring 400. On the side of the first housing part 100, a collar is provided around the spring 400 on the outside. The two collars enclose the spring on both sides and ensure that the spring 400 runs without jamming.

FIG. 5a also shows that the conductor 132 is guided into the first housing part 100 by a seal 138. A cap 137 is additionally placed around the conductor 132 and fastened to the first housing part 100 by snap elements.

The conductor 132 comprises a shielding 136. The shielding is folded over within the first housing part 100 and guided via conductive elements up to a sleeve 116, which surrounds the first connection element 112. The sleeve 116 has spring elements. A sleeve 216 can also be seen on the side of the second housing part 200.

In the present embodiment, at least one seal 142 is provided for the mechanically sealed connection of the two housing parts 100, 200. As can be seen, the first housing part 100 has several collars which surround the opening 140. The seal 142 is arranged on a lateral surface of one of the collars, in particular circumferentially around the opening 140. A further collar lies opposite the seal 142.

FIG. 5b shows the sectional view according to FIG. 5a in the connected state. The spring element 400 is compressed here. A gap can be seen between the slide 310 and the first housing part 100 along the insertion direction above the first housing part 100. The fixing element 300 thus exerts a spring force on the first housing part 100 indirectly via the slide 310 and the spring element 400. However, a direct mechanical force is not transmitted by contact between the slide 310 and an outer surface of the housing part 100. The connection is spring-loaded. In the enlarged part in the lower left area of FIG. 5b, the transition between the sleeve 206 of the lower housing part 200 and the upper sleeve 116 of the upper housing part 100 can be seen. Spring-loaded contact tabs in the form of inwardly curved partial surfaces of the sleeve 116 of the first housing part 100 come into contact with the sleeve 216 of the second housing part 200.

It can also be seen that the first connecting part 112 is surrounded by an insulating sleeve 113. The sleeve 113 is attached to the first connecting part 112 by a latching element 113.1, which can also be seen in the enlarged section.

Starting from the slide 310, which is part of the fixing element 300, the spring element 400 exerts a spring force in the spring direction 410 on the first housing part 100. The spring direction 410 essentially coincides with the insertion direction.

FIG. 6 shows a further section in a sectional plane V parallel to the sectional plane IVa/IVb. Sectional plane V runs between the two connecting parts 110, 112. The securing element 230 and the temperature sensor 250, which are arranged in the second housing part 200, can be seen. In addition, FIG. 5 shows that the slide 310 as part of the fixing element 300 projects with an extension 330 into a channel 150 of the first housing part 100. Two seals 332 are arranged on the extension 330. In the connected state shown, the extension 330 of the slide 310 comes into engagement with the securing element 230. The securing element 230 detects the extension 330 of the slide 310 and thus recognizes that the on-board power supply connector 1 is in a connected state. For example, a control device can evaluate the safety devices 230 and, for example, apply a voltage to at least one of the conductors 130, 132.

FIG. 7 shows a section along the cut surface VI. A first and second first connection element 110,112 of the first housing part 100 are shown here. These are in direct contact with a respective connection element 210,212 of the second housing part 200. Two spring elements 400 can be seen. One is assigned to each pair of connecting parts 110, 210 and 112, 212. The slide 310 of the fixing element 300 is limited in its upward movement by a stop 160 of the first housing part 100. The slide also has a projection 312 for this purpose. The overlap 100-200 between the first housing part 100 and the second housing part 200 can also be seen in the view.

FIG. 8 schematically shows two versions of stops 160 of the housing part 100, 200, on which the spring element 400 and the slide 310 are mounted.

FIG. 8a shows a spring element 400, which comprises a tension spring 400. The restoring force of the spring 400 therefore acts in the direction of a compression of the spring 400. A movement of the fixing element 300 causes an extension of the spring 400.

The stop 160 of the first housing part 100 is therefore positioned between the slide 310 and the spring element 400.

In the embodiment of FIG. 8b, the spring element 400 is realized by a compression spring 400. In this embodiment, the stop 160 of the first housing part 100 is arranged above the spring 400 and the slide 310.

### LIST OF REFERENCE SIGNS

100 Housing
110 Connecting part
112 Connecting element
113 Sleeve
113.1 Latching element
116 Sleeve
120 Lever bracket
130 Conductor
132 Conductor
136 Shielding
137 Cap
138 Seal
140 Opening
142 Seal
150 Channel
160 Stop
200 Housing part
201 Housing part
206 Sleeve
210 Connecting part
214 Cap
216 Sleeve
220 Fastener
230 Securing element
240 Opening
242 Collar
250 Temperature sensor
300 Fixing element
310 Slide
312 Projection, collar
320 Lever
330 Extension
332 Seals
400 Spring
410 Spring direction

1-13. (canceled)

14. On-board power supply connector, in particular for high-voltage on-board power supply, comprising:
a first connecting part arranged in a first housing part;
a second connecting part which is congruent with the first connecting part and is arranged in a second housing part; and
a spring element mounted on one of the two housing parts,
wherein, in a connected state of the on-board connector, the two housing parts are fixed relative to one another in such a way that the spring element exerts a spring force from a first of the two housing parts onto the second of the two housing parts in a spring direction, so that the spring force causes a contact pressure between the first connecting part and the second connecting part.

15. On-board power supply connector of claim 14 further comprising
a fixing element which mechanically connects the spring element to the first and/or the second housing part in the connected state of the on-board connector, wherein
the fixing element is arranged in a captive manner on a housing part and/or the spring element is arranged between a housing part and a part of the fixing element, in particular a cover, and in particular is encased in a captive manner.

16. On-board power supply connector of claim 15,
wherein the fixing element comprises a slide, in particular as the cover, which is arranged in a captive manner on one of the housing parts, in particular the first housing part, and/or
is guided and/or displaceably mounted on one of the two housing parts, in particular the first housing part, in particular is displaceably mounted substantially parallel to the spring direction and/or has a stop on one of the housing parts, in particular the first housing part.

17. On-board power supply connector of claim 15,
wherein the fixing element has a retaining element, wherein the retaining element, in particular
in the connected state is engaged with a fastening means on one of the housing parts, in particular the second housing part, and/or
is mounted on one of the two housing parts, in particular the first housing part, and/or on the slide and/or
comprises a fastening lever mounted on one of the two housing parts, in particular the first housing part, and/or on the slide so as to be pivotable about an axis substantially perpendicular to the spring direction, wherein in particular a lever holder locks the fastening lever in the connected state.

18. On-board power supply connector of claim 15,
wherein the spring element is arranged in a captive manner on one of the two housing parts, in particular the first housing part, and/or on the fixing element.

19. On-board power supply connector of claim 14,
wherein one of the connecting parts has a sleeve-shaped receptacle and one of the connecting parts has a rod-shaped plug-in element which is congruent with the receptacle, in particular,
the connected state, the plug-in element is inserted into the receptacle and/or the receptacle tapers from an opening on the front face towards a base, in particular tapers conically and/or that the plug-in element tapers towards its front face, in particular tapers conically and/or
in the connected state, an inner lateral surface of the receptacle and an outer lateral surface of the plug-in element are in direct contact with one another, in particular that a gap is arranged between the front face of the plug-in element and the base of the receptacle and/or
a front faced end piece, in particular made of an insulating material, is arranged on the plug-in element and/or
an insulator is arranged on the front face of one of the connecting parts and at least partially covers the front face.

20. On-board power supply connector of claim 14,
wherein the first housing part has an opening and/or the second housing part has an opening and/or
in the connected state, at least one of the housing parts is at least partially inserted into the opening of the other of the housing parts, in particular
in the connected state the first housing part is inserted into the opening of the second housing part and/or
in the connected state, the second housing part is inserted into the opening of the first housing part.

21. On-board power supply connector of claim 14,
wherein at least one circumferential seal is arranged on a lateral surface of one of the housing parts which faces the respective other housing part, in particular on an outer and/or on an inner lateral surface, in particular in the region of the opening of the housing part, which seal is in contact with an inner lateral surface of the other housing part in the connected state.

22. On-board power supply connector of claim 14,
wherein one of the connecting parts is attached to an electrical conductor, in particular to a stranded conductor, and/or
one of the housing parts has a conductor receptacle for receiving the conductor, in particular
an axial extension of the conductor receptacle runs at an angle, in particular essentially perpendicular to the spring direction and/or
the conductor receptacle has at least one seal surrounding the electrical conductor.

23. On-board power supply connector of claim 22,
wherein the electrical conductor has a shielding which is at least partially electrically connected to at least one sleeve surrounding at least one connecting part in the connected state and/or
one of the housing parts is embedded in an electrically conductive housing which, in the connected state, is connected in particular to the shielding of the conductor.

24. On-board power supply connector of claim 14,
wherein at least two first connecting parts are arranged in the first of the two housing parts and/or at least two second connecting parts are arranged in the second of the two housing parts and/or
a respective spring element is assigned to one of the connecting parts in each case.

25. On-board power supply connector of claim 15,
wherein a first of the two housing parts has a securing channel, through which in particular a part of the fixing element is guided, in particular into the second of the two housing parts, in particular in the plug-in direction,
wherein in particular a seal is arranged circumferentially on an outer circumferential surface of the fixing element, which seal is circumferentially in contact with the inner circumferential surface of the securing channel, in particular in the connected state and/or a seal is arranged circumferentially on an inner circumferential surface of the securing channel, which seal is circumferentially in contact with the outer circumferential surface of the fixing element, in particular in the connected state and/or
the fixing element actuates a fuse element in the connected state, in particular closes a fuse switch, the fuse element being arranged in particular in the second of the two housing parts and/or
the fuse element is aligned with the fuse channel, in particular in the plug-in direction.

26. On-board power supply connector of claim 25,
wherein a temperature sensor is arranged in one of the housing parts, in particular in the second housing part, in particular between at least two connecting parts, in particular second connecting parts.
